(19) United States
(12) Patent Application Publication
(10) Pub. No.: US 2023/0114741 A1
(43) Pub. Date: Apr. 13, 2023

(54) Lithium-Ion Auxiliary Power Supply with Recharge Voltage Control for Secondary HVAC System in Commercial Trucks

(71) Applicants: Kennon GUGLIELMO, San Antonio, TX (US); Adam SCHUMANN, San Antonio, TX (US); Brent LUDWIG, San Antonio, TX (US); Matthew MARTIN, San Antonio, TX (US); Bruno BALOCCO, Long Beach, CA (US); Eric J. KASTANIS, San Antonio, TX (US); EControls, LLC, San Antonio, TX (US)

(72) Inventors: Kennon Guglielmo, San Antonio, TX (US); Adam Schumann, San Antonio, TX (US); Brent Ludwig, San Antonio, TX (US); Matthew Martin, San Antonio, TX (US); Bruno Balocco, Long Beach, CA (US); Eric J. Kastanis, San Antonio, TX (US)

(73) Assignee: EControls, LLC, San Antonio, TX (US)

(21) Appl. No.: 17/904,793

(22) PCT Filed: Feb. 24, 2021
(86) PCT No.: PCT/US2021/019455

§ 371 Date: Aug. 23, 2022

Related U.S. Application Data
(60) Provisional application No. 62/980,848, filed on Feb. 24, 2020.
(60) Provisional application No. 62/980,855, filed on Feb. 24, 2020.

(51) Int. Cl. H02J 7/14; H01M 10/0525; H02J 7/00; H01M 10/42; H01M 4/58; H02J 7/34; B60R 16/033

(52) U.S. Cl. CPC H02J 7/1423; H01M 10/0525; H02J 7/0018; H01M 10/425; H01M 4/5825; H02J 7/342; B60R 16/033; H01M 2010/4271; H01M 2220/20

(57) ABSTRACT

Disclosed embodiments involve a rechargeable lithium-ion battery module assembly for use as an auxiliary power unit (APU), particularly in commercial trucks. Battery module assembly is recharged through the semi-trailer truck's alternator during engine operation. Battery module assembly has active voltage control capabilities to reduce charge time. Each battery array has two collector plate printed circuit board assemblies (PCBA) and two banks of lithium iron phosphate (LFP) battery cells. Individual battery cells are wire bonded to the collector plate PCBs, one of such PCBs incorporates a battery management system to monitor the electrical parameters and state of charge of the battery cells in the system. Battery cells are thermally coupled to an aluminum enclosure with a thermal gap filling material. Using different chemistries for the APU and the starting battery of the commercial truck, and methods of sequential charge and discharge cycles of each, without any other discrete device.

### CLAIM OF PRIORITY TO PRIOR APPLICATIONS

The present application claims the benefit of the filing dates of U.S. Provisional Application, Ser. No. 62/980,855, filed on Feb. 24, 2020, and U.S. Provisional Application, Ser. No. 62/980,848, filed on Feb. 24, 2020. By this reference, the full disclosures, including the claims and drawings, of U.S. Provisional Applications, Ser. Nos. 62/980,985 and 62/980,848 are incorporated herein as though now set forth in their entirety.

### BACKGROUND OF THE INVENTION

### 1. Field of the Invention

The present disclosure relates to rechargeable battery-powered auxiliary power supplies for heating ventilation and air conditioning, as well as to related aspects of their use. More particularly, the present disclosure is most directly related to lithium-ion battery-powered auxiliary power units in commercial trucks with sleeper cabins or other vehicles that idle for extended periods of time.

### 2. Description of Related Art

Before reviewing the particular field of the invention, it may be helpful to consider background information on rechargeable lithium-ion batteries in general. Rechargeable lithium-ion batteries were developed in the 1970's, and many of their benefits and potential industrial uses were well understood even then. Although commercial adoption was initially slow, they became much more widely popular by the 1990's. They are principally characterized by reference to the type of intercalated lithium compound used as the cathodes in their battery cells. Lithium metal oxides have been the most successful, with lithium cobalt oxide (LCO, or LiCoO₂) being most popular for use in industry, although its use has not been without drawbacks, particularly with respect to thermal runaway and related safety concerns. Through the course of development, substantial improvements have been realized by doping of lithium cathode formulations with additional metals such as nickel, manganese, and aluminum. Various innovations have also involved core-shell particle cathodes, improved anodes, and the use of solid lithium polymer electrolytes, and still other innovations have led to smaller cathode particle sizes, increased electrode surface areas, and other improvements in overall battery capacity.

Today, the most popular lithium-ion batteries are of the LCO type, with lithium nickel cobalt aluminum oxide (NCA, or LiNiCoAlO₂) and lithium nickel manganese cobalt oxide (NMC, or LiNiMnCoO₂) being particularly popular. Other alternative cathode compositions have included other lithium metal oxides such as lithium manganese oxide (LMO) and lithium manganese nickel oxide (LMNO), and other lithium-ion chemistries can be considered for particular needs. Lithium metal phosphates, for instance, have also long been theoretically available for improved cycle counts, shelf life, and safety, although other performance trade-offs have made them less popular than LCO types amongst manufacturers. As one particular type of lithium metal phosphate, lithium iron phosphate (LFP, or LiFePO₄) batteries have long been known as an available type of rechargeable lithium-ion battery, with various pros and cons relative to NCA, NMC and other LCO batteries.

As a particular example of successful implementation of lithium-ion batteries in other fields, Tesla, Inc. has popularized the use of NCA batteries for its Model S electric cars. Their NCA batteries work well largely due to their high energy density, although they tend to have relatively low thermal stability, with a thermal runaway temperature of around 150° C. Tesla's battery manufacturing method helps balance the benefits and risks by safely interconnecting hundreds of smaller battery cells in a much larger assembly, in a way that enables the necessary energy density while minimizing the risk of arcing and overheating. Within the larger assembly, the hundreds of smaller battery cells are connected in groups, each group including a parallel arrangement of numerous cells connected by wire bonds to adjacent busbars. The busbars of those groups are then combined in series to produce a much larger assembly that meets the power demands for an electric car. The method permanently connects each terminal of each cell into the overall assembly, although rather than using traditional methods of soldering, resistive spot welding, or laser welding, Tesla uses ultrasonic vibration welding, and the wire bonds are made of low resistance wire that allows for expected currents to pass through without significant overheating. Each wire bond is only about a centimeter in length, with one end bonded to the battery terminal and the other end bonded to an aluminum busbar conductor, which in turn is electrically joined in a circuit with other busbars. In the event of overcurrent such as with a short circuit or the like, each wire bond can serve as a fuse that breaks to prevent excessive overheating.

LFP batteries tend to have lower energy densities than NCA and NMC batteries. However, LFP batteries are generally safer due to their greater thermal and chemical stability. Thermal runaway for LFP batteries typically does not occur until around 270° C., which improves safety and decreases the likelihood of catastrophic failure. LFP batteries are also more stable under short circuit or overcharge conditions and will not readily decompose at high temperatures. As other arguable advantages, LFP batteries also tend to have greater power density (i.e., they can source higher power levels per unit volume) as well as greatly increased cycle life in comparison to lead-acid batteries. While common lead-acid batteries have an average life of 300 to 500 cycles with 20% degradation of stored charge, LFP batteries can last over 2000 to 3000 cycles with the same 20% or possibly less, such as 10% degradation of stored charge.

Meanwhile in the field of the present disclosure, safety guidelines and federal regulations limit the number of hours a truck driver is allowed to drive. Often when a driver is required to rest or sleep, there are little to no options to do this outside of the vehicle. Vehicle mounted secondary heating ventilation and air conditioning (HVAC) systems are utilized to provide drivers a comfortable environment while remaining in the vehicle, especially when outside temperatures are severe.

Despite long availability of auxiliary power units (APUs) to operate vehicle mounted HVAC systems, and to benefit other functions of the vehicle, existing designs are not without their drawbacks. Currently, there are two options for APU designs—diesel powered or electric battery-based models. Diesel models are more powerful and can run for long periods but consume fuel to operate and are more expensive to maintain or replace, when compared with electric units. Electric APUs are limited in cooling capacity and runtime by the capacity of their batteries. However, they generate virtually zero emissions when discharging, and are therefore compliant with current emission standards. Many battery-based APUs utilize conventional lead-acid batteries.

Many choose to use electric APUs, because they are cheaper, quieter, and do not use additional fuel during operation. However, existing electric APUs that use conventional lead-acid batteries tend to charge slowly, provide insufficient run-time, have limited power capabilities, and often fail to provide enough cooling or heating for a driver's full rest periods, especially in extreme climates. Also, after numerous charge and discharge cycles, conventional lead-acid batteries in APUs begin to degrade rapidly further shortening their run-time throughout their lifetime. For example, a new lead-acid battery utilized in the APU context may have an initial maximum run-time for a discharge cycle of about 6 to 8 hours. However, after multiple charge and discharge cycles, typical lead-acid batteries in APUs might have a reduced run-time of approximately 4 to 5 hours, typically an insufficient amount of a time for a full rest period.

As a result of many of the above-mentioned and other reasons, there is a need for a lithium-ion battery APU as an alternative that has greater energy capacity, a longer life cycle, charges quickly, and reliably operates for the duration of a full rest period, without the drawbacks of a diesel-powered model. Therefore, despite the well-known characteristics and long availability of rechargeable LFP and other lithium-ion battery technologies, there are still substantial and long-felt unresolved needs for the implementation of improved battery technology in the transportation industry. For an even better understanding of some of the foundational concepts associated with the presently disclosed embodiments, commonly owned U.S. Non-Provisional patent application Ser. No. 16/193,071 is incorporated herein by reference in its entirety.

### SUMMARY OF THE INVENTION

The innovations of preferred embodiments of the present disclosure improve operations of electric auxiliary power units (APUs). Operations are improved in part, by enabling vehicle-mounted secondary heating ventilation and air conditioning (HVAC) systems in commercial trucks, and other vehicles, to run for longer periods to allow drivers to comfortably sleep or relax the entire necessary rest period without having to consume fuel by running a diesel APU, or by idling the main truck engine. The improved runtime when compared to lead-acid batteries is possible due in part to the greater energy density of the chemical properties of lithium-ion batteries.

Further, the lithium-ion battery cells incorporated into the presently disclosed embodiments charge significantly faster, degrade at a much slower rate, and they further maintain greater charge capacity for significantly longer than conventional lead-acid batteries. It is contemplated that the battery modules in the disclosed battery module assembly are recharged by the commercial truck's alternator during operation of the engine. Disclosed embodiments have active voltage control capabilities to reduce the charge time and improve the life cycle of the battery.

Alternatively, preferred embodiments are capable of being charged by truck stop electrification, using an external power supply sourcing power from the grid when available, to recharge the batteries and/or simultaneously to run the electric APU.

Presently, preferred embodiments of the present invention's exterior dimensions are consistent with a double length Group 31 form factor and consists of one positive and one negative cell array each with two banks of cells, for a total of four banks in the battery module assembly. Each bank of cells contains 72 individual lithium-ion battery cells connected in parallel in preferred embodiments. Within each module, individual battery cells are connected using an approach that is comparable to the Tesla method of wire bonded battery manufacture. An important difference from Tesla, however, involves the use of LFP battery technologies rather than NCA or other LCO battery technologies, as previously discussed. Individual battery cells are wire bonded to collector plate printed circuit board assemblies (PCBA) in each cell array.

An APU system will include two of the preferred embodiment modules and would typically include 4 Group 31 lead acid batteries.

Disclosed embodiments of the positive and negative cell array are similarly assembled in a manner that allows components such as the positive and negative bus terminals to protrude from the plastic lid of the battery module assembly. The positive cell array contains a collector plate printed circuit board PCBA that has an integrated battery management system (BMS) that monitors and/or actively manages battery cell characteristics such as temperature, voltage, and current for the entire system. Located between the battery cells and the collector plates PCBA are plastic battery trays and a structural adhesive. A structural adhesive is used between the top plastic battery tray and the collector plate PCBA. Additionally, the same adhesive is used between the battery cells and the top and bottom plastic battery trays.

### BRIEF DESCRIPTION OF THE DRAWINGS

FIG. 1 shows a perspective view of a preferred embodiment of the lithium iron phosphate battery module assembly 100.

FIG. 2A shows a side view of a semi-trailer truck 200 incorporating the battery module assembly 100.

FIG. 2B shows a schematic of alternator 204 and battery module assembly 100.

FIG. 3 shows an exploded view of battery module assembly 100. Battery module assembly 100 includes a positive cell array 304 and a negative cell array 306.

FIG. 4 shows a perspective view of a preferred embodiment of the negative cell array 306.

FIG. 5 shows an exploded view of negative cell array 306.

FIG. 6 shows a perspective view of a preferred embodiment of the positive cell array 304.

FIG. 7 shows an exploded view of positive cell array 304.

FIG. 8 shows collector plate PCBA 704 which includes an integrated battery management system (BMS) 602.

FIG. 9 shows a cross sectional view of an individual battery cell within a sub-assembly.

FIG. 10 shows a simplified graphical representation comparing sample discharge curves over time of a typical lead-acid battery 1020 and the disclosed LFP battery module 1010.

FIG. 11 shows a simplified graphical representation comparing sample charge curves over time of a typical lead-acid battery 1120 and the disclosed LFP battery module assembly 1110.

FIG. 12 shows a simplified graphical representation comparing sample charge curves over time of an NMC battery 1220 and the disclosed LFP battery cell 1210.

FIG. 13 is a schematic illustrating the equivalent circuit model 1300 used to determine a battery cell's 506 OCV and dynamic parameter characterization.

FIG. 14 is a simplified graphical representation of an estimated state of charge curve.

FIG. 15 is a simplified schematic illustrating a prior art two-battery system.

FIG. 16 is a simplified schematic illustrating the incorporation of a dual chemistry approach according to teachings of the present disclosure.

FIG. 17 is a graph showing the voltage curve dynamics for a conventional lead-acid battery and the preferred lithium-ion battery system as the voltage out for each battery type relates to the state of charge of each of the battery types.

FIG. 18 shows a block diagram illustrating the active balancing strategy for each of the battery banks 402a-402d.

### DETAILED DESCRIPTION OF PREFERRED EMBODIMENTS

The following descriptions relate to presently preferred embodiments and are not to be construed as describing limits to the invention, whereas the broader scope of the invention should instead be considered with reference to the claims, which may be now appended or may later be added or amended in this or related applications. Unless indicated otherwise, it is to be understood that terms used in these descriptions generally have the same meanings as those that would be understood by persons of ordinary skill in the art. It should also be understood that terms used are generally intended to have the ordinary meanings that would be understood within the context of the related art, and they generally should not be restricted to formal or ideal definitions, conceptually encompassing equivalents, unless and only to the extent that a particular context clearly requires otherwise.

For purposes of these descriptions, a few wording simplifications should also be understood as universal, except to the extent otherwise clarified in a particular context either in the specification or in particular claims. The use of the term “or” should be understood as referring to alternatives, although it is generally used to mean “and/or” unless explicitly indicated to refer to alternatives only, or unless the alternatives are inherently mutually exclusive. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,” “comprising” or “including.” Likewise, “another” object may mean at least a second object or more.

### Preferred Embodiments

The following descriptions relate principally to preferred embodiments while a few alternative embodiments may also be referenced on occasion, although it should be understood that many other alternative embodiments would also fall within the scope of the invention. It should be appreciated by those of ordinary skill in the art that the techniques disclosed in these examples are thought to represent techniques that function well in the practice of various embodiments, and thus can be considered to constitute preferred modes for their practice. However, in light of the present disclosure, those of ordinary skill in the art should also appreciate that many changes can be made relative to the disclosed embodiments while still obtaining a comparable function or result without departing from the spirit and scope of the invention.

### Battery Module Assembly

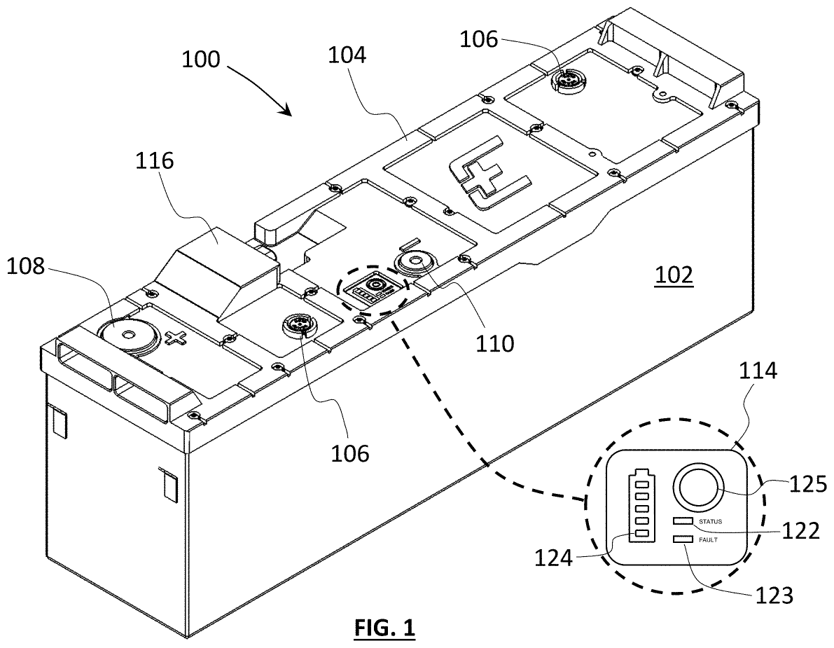

Turning now to FIG. 1, there is shown a preferred embodiment of the lithium iron phosphate (LFP) battery module assembly 100. The exterior dimensions of battery module assembly 100 are consistent with a double length Group 31 form factor, although it should be understood by those of ordinary skill in the art that the disclosed features, as well as the advantages derived therefrom, could be incorporated into other battery module form factors while still providing all or most of the advantages of the battery module assemblies herein described. Note that being “consistent” with a form factor allow for flexibility in actual size. It is also anticipated that certain aspects of embodiments may be in other form factors as custom applications require.

Visible in FIG. 1 are the aluminum enclosure base 102 and the plastic lid 104. Preferred embodiments include openings for ports in the plastic lid 104 for input and output. The positive bus terminal 108 and negative bus terminal 110 are accessible through the plastic lid 104. Two vent patches 106 and a display 114 with a touch pad HMI 125 are also visible protruding from the plastic lid 104. Behind bulkhead 116 is 6-pin flange receptacle 118. It will be evident to those skilled in the art that an alternative number or type of ports could be present while still being within the scope of the disclosed embodiments.

Auto sequencing memory (“ASM”) button pad display 114 is configured and adapted to display diagnostics for the battery module assembly 100. A user can press button pad 125 to “wake” the display 114 from sleep mode. A coded push can be used for diagnostics. There is a status bar 222 that indicates the present status of the battery module assembly 100. If the fault bar 223 lights up red, this indicates that there is a fault with at least one module 100. With respect to a present state of charge, there are five bars 224 that light up green and indicate the battery charge level of battery module assembly 100. The five bars 224 will show charge status in increments of approximately 20% of charge ranging from 0%, to 100% based on the number of LEDs illuminated. For example, one bar indicates that the charge is very low (around 20%) and five bars indicates the battery module assembly 100 is fully charged (100%). In preferred embodiments, when the state of charge percentage is indicated to be 0%, there remains a nominal charge in one or more of the battery cell banks to protect the battery module assembly 100 from over-discharging, as well as to protect battery module assembly 100 at time when it sits idle and unused for a period of time. The determination for the state of charge of the battery module assembly 100 is described in further detail below in the section entitled “State of Charge Determination.”

When the battery module assembly 100 is at or near full charge, the overall state of charge for battery module assembly 100 reflects the average output of all of the cell banks in the battery module assembly 100. When the overall state of charge for battery module assembly 100 drops below a threshold percentage, the state of charge display will represent the lowest charged battery cell bank of all of the battery cell banks in battery module assembly 100. In preferred embodiments, the threshold may be set at 80% state of charge overall for battery module assembly 100. Other thresholds may be selected. Display 114 also has a fault indicator 123 which is lit when battery module assembly 100 experiences a fault condition. Alternative embodiments may incorporate a digital numerical display for indicating the percentage of the state of charge for battery module assembly 100.

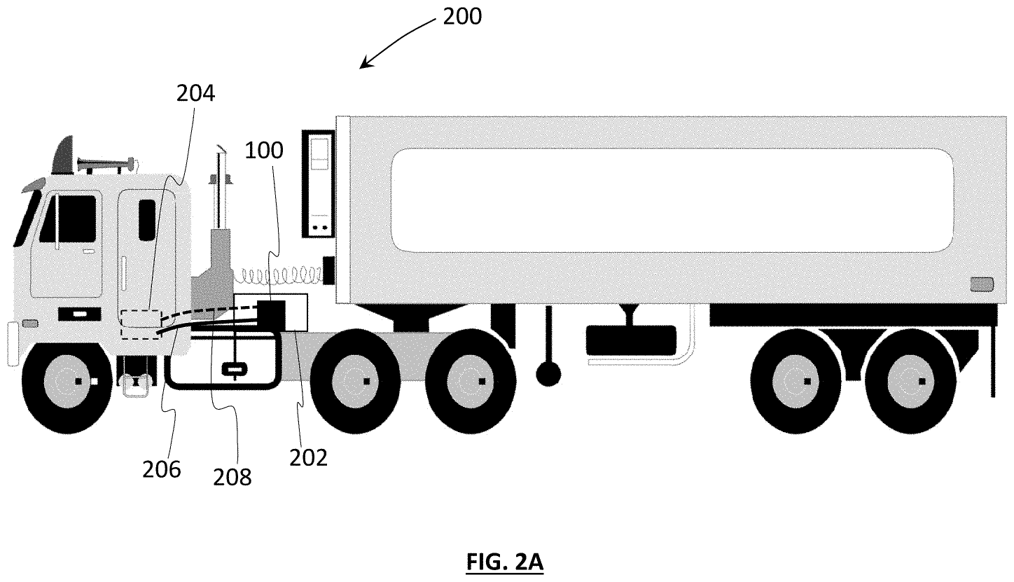

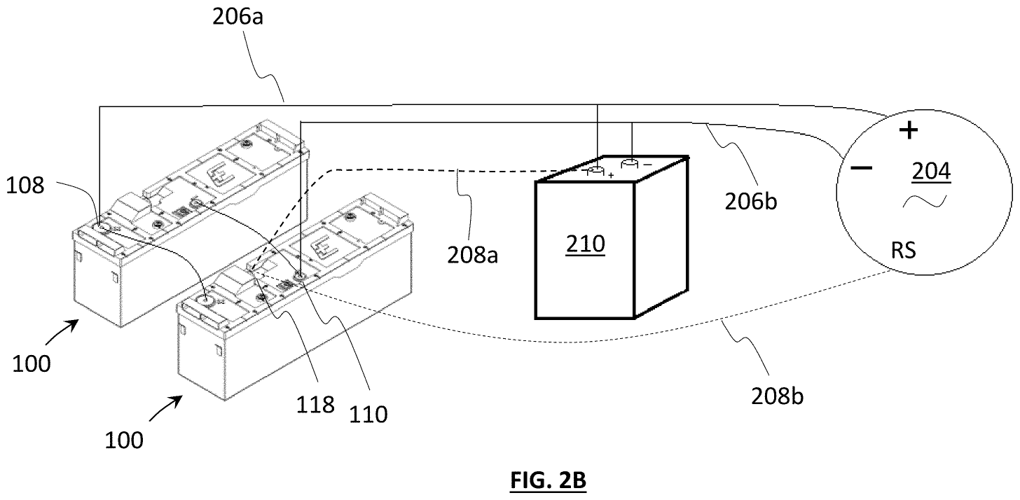

Turning now to FIG. 2A, there is shown a side view of a semi-trailer truck 200 onto which the disclosed battery module assembly 100 may be mounted. The battery module assembly 100 is contained in a compartment or housing 202 (illustrated here as a rectangle) attached to the frame of semi-trailer truck 200 behind the cab and provides power to various truck functions, such as the vehicle-mounted heating ventilation and air conditioning (HVAC), the battery module assembly 100 particularly being operative when the main drive engine (not shown) of semi-trailer truck 200 is not running.

The alternator 204 (illustrated as a dashed-line box) of semi-trailer truck 200 connects to battery module assembly 100 with charge cables 206 and remote sense wire 208. The alternator 204 charges battery module assembly 100 when the main drive engine is running. Alternator 204 operates as a constant voltage source and must be appropriately sized in order to adequately charge battery module assembly 100. Additionally, preferred embodiments of battery module assembly 100 are capable of being charged by truck stop electrification, using an external power supply sourcing power from the grid when available, to recharge and/or simultaneously to operate the battery module assembly 100.

Due to limited alternator capability and limited charge time, lead-acid banks typically consist of up to 4 ground 31 lead-acid batteries in parallel. Although different APUs may operate at various values, a new lead-acid battery bank, while operating at 50-55 A with some on/off cycling, typically achieves a maximum of about 6-8 hours of run-time In contrast, while operating at the same 50-55 A with the same on/off cycling, battery module assembly 100 can achieve a run-time of up to 13 hours, or more, before requiring recharging. Due to its LFP chemistry, battery module assembly 100 can safely discharge 90% of its capacity in a discharge cycle. In contrast, lead-acid batteries can only discharge 80% before permanent damage occurs to the overall capacity.

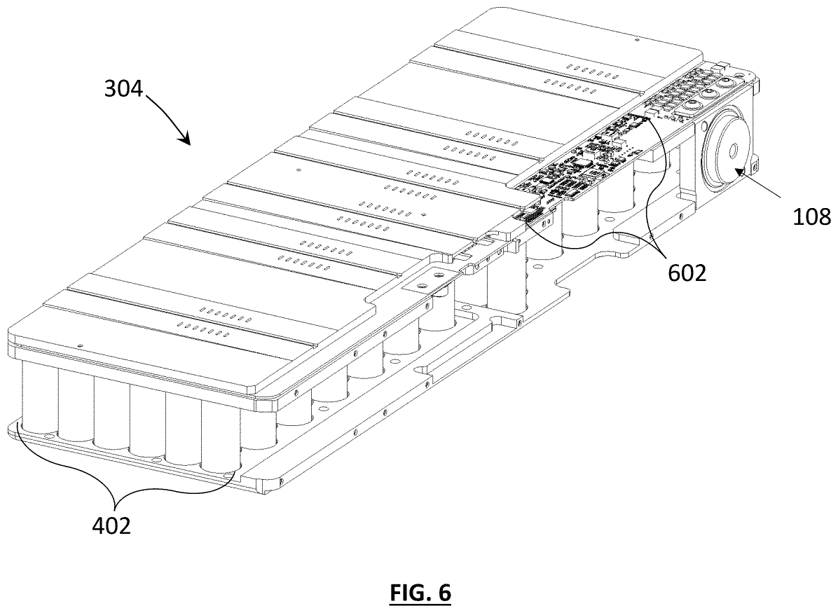

While common lead-acid batteries have an average life of 300 to 500 cycles with 20% degradation of stored charge, battery module assembly 100 can last over 2000 to 3000 cycles, or up to six times as many, with the same 20% or possibly less, such as 10%, degradation of stored charge. Since operating times are reduced over the period of numerous charge and discharge cycles, battery module assembly 100 can operate roughly twice the duration of a conventional lead-acid APUs. Those skilled in the art will recognize that the image is for illustrative purposes and the present invention can be incorporated into a semi-trailer truck 200 by other means, achieving the same results. Additionally, it should be noted that the values presented are not intended to be limiting and are for illustrative purposes. It is contemplated that the alternator 204 is capable of remote voltage sensing of the starting battery voltage, and battery module assembly 100 will be capable of actively controlling this remote sense input to reduce charge time and improve the life cycle of the battery module assembly 100. Conventional charging methods often result in a lower voltage at the battery than the voltage being seen by the alternator 204. Various factors may cause the voltage seen at the battery module assembly 100 to be significantly lower than the voltage at the terminals of alternator 204. Voltage drop is affected by wire length, wire gauge, aging or corroded cables, loose cables, cables that are improperly connected, and the overall charging path topology among other factors. An opportunity to increase the voltage seen at the battery module assembly 100 is detected by sensing charge current and starting battery voltage at the remote sense wire 208. If an opportunity to safely increase the output voltage of alternator 204 is detected, battery module assembly 100 can add or subtract small voltage offsets in the remote sense input of alternator 204, which can cause the alternator 204 to increase voltage output to compensate for the voltage drop, ensuring an optimal operating voltage and current being received at the battery module assembly 100. Those skilled in the art will recognize that additional voltage injected into the alternator's remote sense circuit forces higher charge current into the battery module assembly 100, achieving a full state of charge faster. Additional voltage being sent by the alternator 204 in this method can result in a full charge in about half the time of conventional charging methods. Other advantages, such as limiting current initially to decrease required alternator size or limiting voltage to protect from an alternator that is regulating too high, can also be seen. Turning now to FIG. 2B, there is shown a more detailed view of the alternator 204 and battery module assembly 100. The alternator 204 and battery module assembly 100 are connected by charge cables 206 and remote sense wires 208. In addition to charging the truck starting battery 210, the charge cables 206a & 206b connect to the battery module assembly 100 allowing the alternator 204 to charge the battery module assembly 100 between use. One charge cable 206a connects to the positive bus terminal 108 and one charge cable 206b connects to negative bus terminal 110. The remote sense wire 208 connects directly to the battery module assembly 100 at the 6-pin flange receptacle 118. An input 208a and output 208b occupy two of the pins in the 6-pin flange receptacle 118, which connects to the BMS 602 described in detail in FIGS. 6 & 8). The BMS 602 measures the voltage of the vehicle's electrical system, where remote sense wire 208 is normally located, and injects an offset voltage. The alternator 204 then increases the voltage output to compensate for the artificial voltage drop, thereby increasing the charge current to the battery module assembly 100. In addition to increasing alternator voltage to increase charging current to battery module assembly 100, the BMS 602 will also limit the magnitude of the applied offset so as to not violate the voltage or current limits of the alternator 204, the voltage limits of the starting battery, the vehicle's electrical systems, or the voltage limits of battery module assembly 100. It will be evident to those skilled in the art that the drawing is not to scale and is only for illustrative purposes detailing how the components are connected.

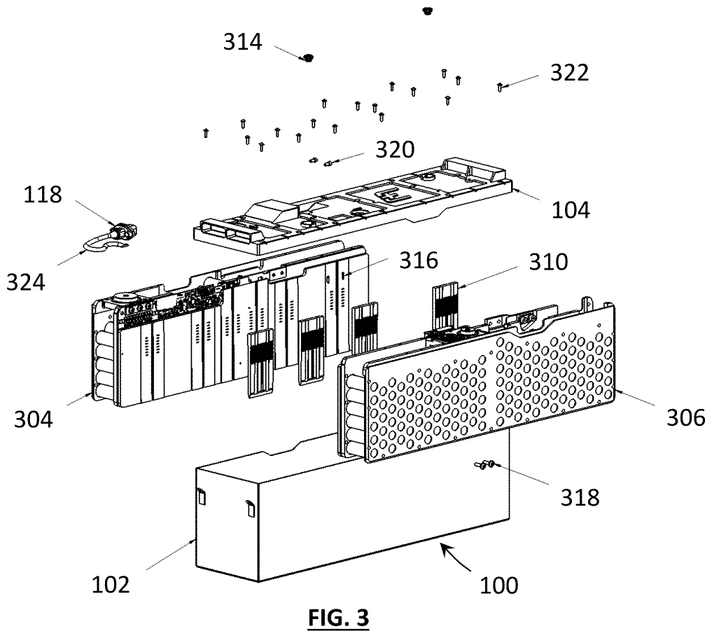

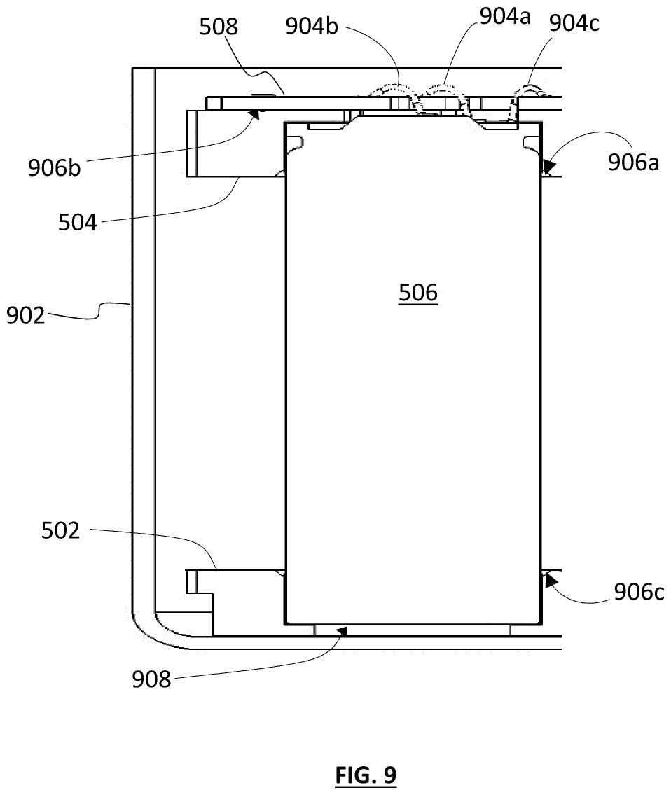

Turning now to FIG. 3, there is shown an exploded view of the battery module assembly 100. The battery module assembly 100 contains two sub-assemblies or cell arrays, one positive 304, and one negative 306. Cell arrays 304 & 306 include a plurality of lithium-ion battery cells 506. Preferably, the battery cells 506 are of the LFP type. Cell arrays 304 & 306 are glued into the aluminum enclosure base 102. Multiple self-locking wedges 310 are installed to spread the cell arrays 304 & 306 apart, and to force contact with the aluminum enclosure 102 and an optional thermal gap filler (as seen in FIG. 9). A plastic lid 104 is then glued and screwed down on top of the sub-assemblies 304 & 306 and enclosure base 102.

A variety of screws are used in the assembly process, preferably HSHC, M5X10 SS 320, and Delta PT 322 are used where appropriate to secure the plastic lid 104 in place. Additionally, fasteners 316 and 318 are preferred to be used to secure the sub-assemblies 304 & 306 and the enclosure base 302 and respectively. However, it will be evident to those skilled in the art that several alternative attachment methods can be used to secure individual components in place throughout the battery module 100.

Also visible in FIG. 3 is 6-pin flange receptacle 118, and when battery module assembly 100 is fully assembled, 6-pin flange receptacle 118 is located under bulkhead 116 and is attached with a flying lead wire harness 324 to the battery management system (BMS) 602. Additionally, vent plugs 314, preferably TEMISH, are used in the plastic lid 104, to prevent water and dust from entering the battery module assembly 100.

### Negative Cell Array

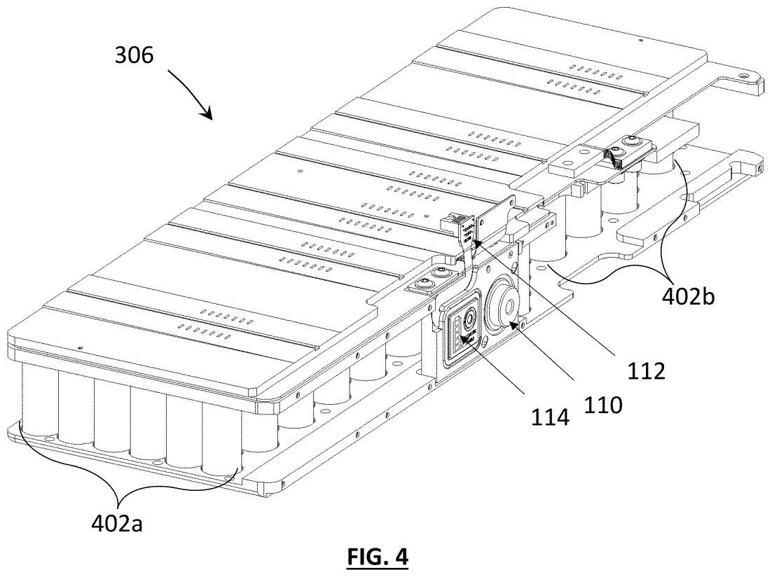

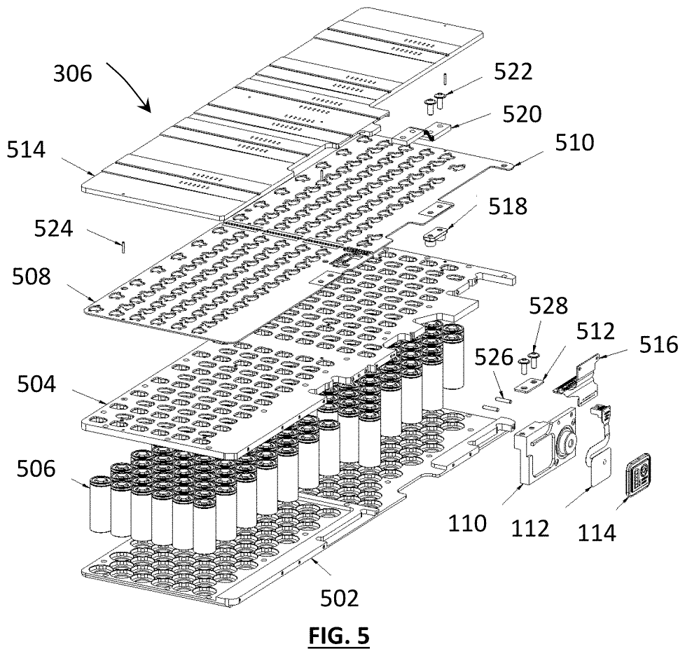

Turning now to FIG. 4, which shows a closer view of a preferred embodiment of sub-assembly or negative cell array 306. Included in each battery module 100 is one negative cell array 306 and one positive cell array 304 (as seen in FIG. 5). Each sub-assembly 304 & 306 contain two banks of cells 402, shown here as 402a & 402b for a total of four in each battery module assembly 100. Also shown, is the negative bus terminal 110, a light emitting diode (LED) dome 404, and touch pad 114 all of which protrude from the plastic lid 104 when battery module 110 is fully assembled.

Turning now to FIG. 5, there is shown an exploded view of a preferred embodiment of negative cell array or sub-assembly 306. Each sub-assembly 304 & 306 contains two banks of cells 402 which are made up of LFP battery cells 506 in parallel. Presently, preferred embodiments include 72 cells 506 in each bank 402. The cells 506 are held in place between a cell tray bottom 502 and cell tray top 504. Dowel pins 526 are inserted into the cell tray bottom 502 to aid in securing the lid to the negative cell array 306 when assembled. Each cell 506 is wire bonded to a collector plate printed circuit board assembly (PCBA) 508 & 510. A flex bus 520 is attached and held into place on the collector plate PCBA 510 with screws 522, and a nut plate 518. A wire guard tray 514 is held in place with dowel pins 524 over the collector plates 508 & 510.

Preferred embodiments of negative cell array 306 also include negative bus terminal 110, LED dome 404, and touch pad 114. Negative bus terminal 110 fits over a flex circuit 516 and is secured with a washer plate 512 and screws (HSFBHC, M616) 528 when negative cell array 306 is assembled. Those skilled in the art will recognize that several alternative attachment methods can be used with similar results to secure the components in place in the negative cell array 306, and the components described above only represent a preferred method.

### Positive Cell Array

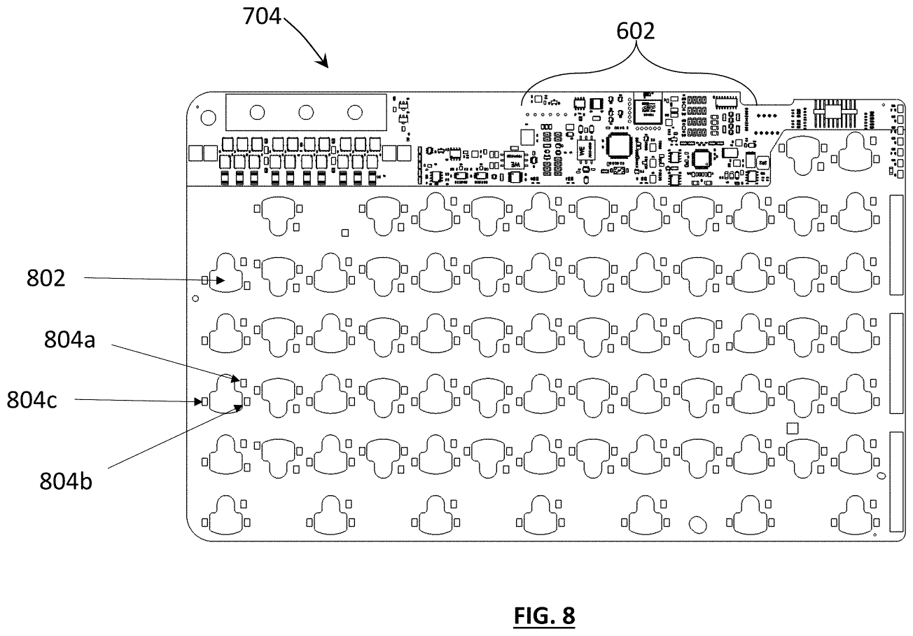

Turning now to FIG. 6, which shows a closer view of a preferred embodiment of the positive cell array 304. The positive cell array 304 is assembled similar to the negative cell array 306 and also contains two cell banks 402 consisting of individual cells 506. When assembled, the positive bus terminal 108 from positive cell array 304 protrudes through the plastic lid 104 of battery module array 100. Also visible, is the BMS 602, which is only present in the positive cell array 304, and will be discussed in further with respect to FIG. 8.

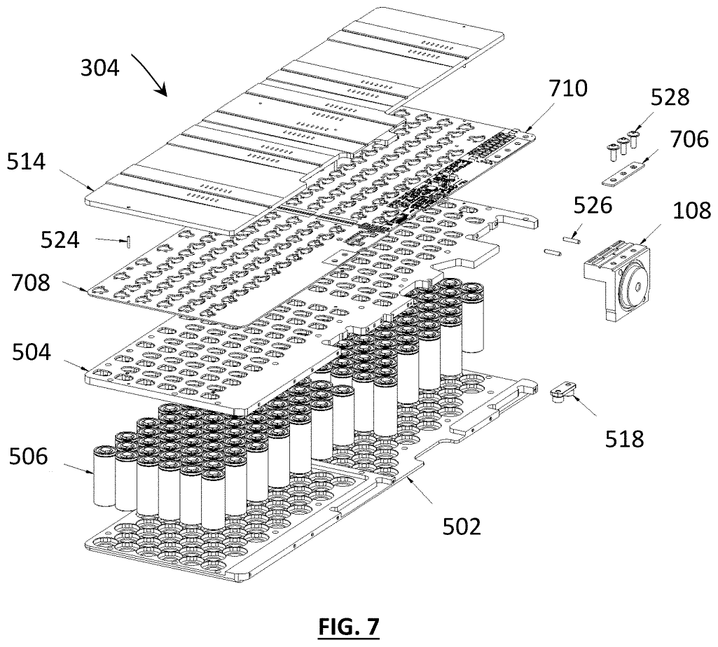

Turning now to FIG. 7, there is shown an exploded view of a preferred embodiment of positive cell array or sub-assembly 304. Individual cells 506 are held in place between a cell tray bottom 502 and cell tray top 504. Dowel pins 526 are inserted into the cell tray bottom 502 to aid in securing the negative cell array 306 to the lid when assembled. Each cell 506 is wire bonded to a collector plate PCBA 702 & 704. A wire guard tray 514 is held in place with dowel pins 524 over the collector plates 702 & 704.

Preferred embodiments of positive cell array 304 also include positive bus terminal 108. Positive bus terminal is secured with screws 528, a nut plate 518, and washer plate 706. Those skilled in the art will recognize that several alternative attachment methods can be used with similar results to secure the components in place in the positive cell array 304, and the components described above only represent a preferred method.

### Collector Plate Printed Circuit Board

Turning now to FIG. 8, there is shown a closer view of a preferred embodiment of a collector plate PCBA 704. The function and construction of collector plate PCBA 704 is similar to other collector plate PCBAs 508, 510, 702 in battery module array 100, but it contains an integrated BMS 602. The BMS 602 monitors the health of the battery cells 506, including the cell voltage, current, and temperature, and actively manages the battery cells 506 if necessary. The BMS also dictates whether additional voltage is required from alternator 204 during a charge cycle to achieve a desired charge current. Each collector plate PCBA 508, 510, 702, 704 is wire bonded to individual cells 506. The wire bonding will be completed using a method similar to the Tesla ultrasonic friction welding method. Several opening 802 on collector plate PCBA 704 are where tiny wires 904a, 904b, 904c (as shown in FIG. 9) will pass through, such that the wires 904a, 904b, 904c will be bonded to both the collector plate PCBA 704 and the battery cell 506. The locations 804a, 804b, 804c shown near each opening 802 are where cells 506 are wire bound to the top of the collector plate PCBA 704. The use of the collector plate PCBA 704 prevents the entire sub-assembly 304 from failing if one battery cell 506 malfunctions because the other cells 506 are still independently connected to the collector plate PCBA 704.

### Lithium-Ion Battery Cells

Turning to FIG. 9, there is shown a cross sectional view of a single battery cell 506. As previously mentioned, the LFP battery cells 506 are surrounded by a protective enclosure 902, preferably constructed of aluminum. Directly above battery cell 506, there is a top plastic battery tray 504. The structural adhesive 906a is used between the top of battery cell 506 and top battery tray 504. Similarly, the same structural adhesive 906b is applied between the top battery tray 504 and the collector plate PCBA 508, 510, 708, 710. It is clearly shown that positive wire 904c and two negative wires 904a & 904b are wire bonded to the top of collector plate PCB 508, 510, 708, 710.

Turning to the bottom of FIG. 9, the structural adhesive 906c is applied between the bottom of battery cell 506 and bottom battery tray 502. Furthermore, a thermal gap filling material 908 may be used between the bottom of battery cell 506 and the bottom of the protective enclosure 902. The gap filling material 908 allows heat to be transferred from the battery cells 506 to the enclosure 902 so it can dissipate from the battery module assembly 100.

Within the battery module assembly 100, a plurality of self-contained battery cells (preferably somewhere in the range from one-hundred sixty (160) to four-hundred (400) cells per battery module assembly 100) are connected in a combination of series and parallel using a wire bonding method. The wire bonding method connects batteries using wire bonds instead of busbars. The wire bonding is achieved through ultrasonic friction welding. By interconnecting batteries with wire bonding, the wire bonds can prevent short circuits while acting as fuses. The wire bonds are made of wire that allows for the expected current to pass through without significant overheating and allows the wire bond to break to prevent over-currents of individual cells. Additionally, current-controlled MOSFETs acting as resettable fuses, or other resettable or conventional fuses, are placed inside battery module assembly 100 in series with the lithium-ion battery cells 506. If the current carrying capacity is exceeded, the fuse will open and prevent the overcurrent from also blowing out the wire bonds. Alternative embodiments of this design may connect battery cells 506 in parallel. Additionally, alternative methods of connecting batteries 506 could include traditional soldering and spot welding.

Each battery cell 506 is wire bonded to a printed circuit board (PCB) on the collector plate 508, 510, 708, 710. There are three wires 904a, 904b, 904c bonded to pads on one of the PCBs 508, 510, 708, 710 for each battery cell 506. Two of the wires 904a, 904b are negative and one of the wires 904c is positive. The purpose of two negative wires is for redundancy, as well as reduced overall resistance. Alternate embodiments may contain variations of the arrangement or numbers of battery cells 506.

### Lithium-Ion Battery Cell Performance

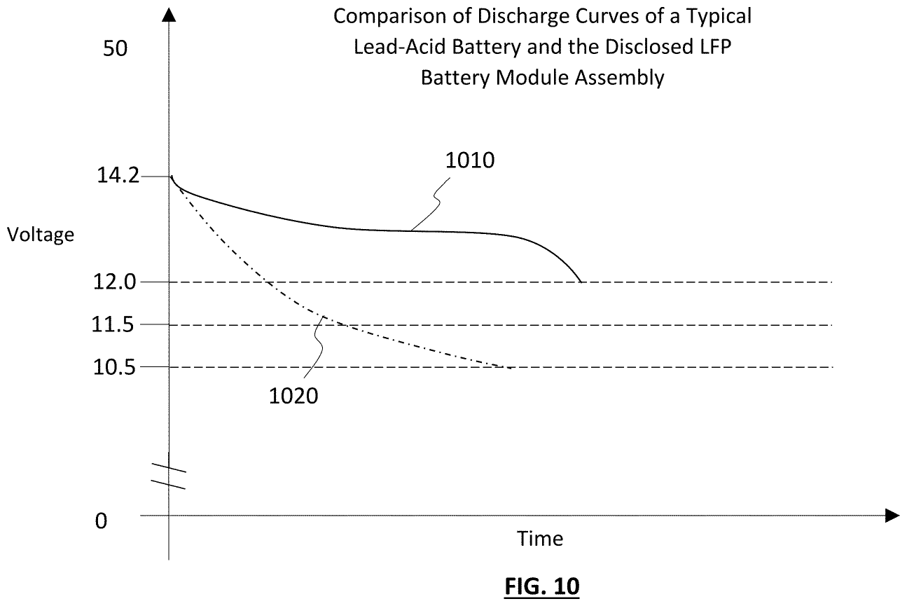

Turning now to FIG. 10, there is shown a graphical representation of a comparison of a constant discharge curve 1020 for a typical lead-acid battery (the dash-dot line) and an equal constant current discharge curve 1110 for the battery module assembly 100 herein disclosed (the solid line). It should be understood that, with a constant current load, the relative discharge time of each curve reflects the relative discharge time of each battery type.

Although both battery module assembly 100 and the typical lead-acid battery are shown at full charge being approximately 14.2 volts, there are stark differences plainly evident in the graph of each discharge curve. During operation of battery module assembly 100, there is shown a decrease in the voltage over time. However, the discharge curve 1010 of the battery module assembly 100 is relatively flat for the majority of the discharge cycle. Accordingly, during most of the discharge cycle, battery module assembly 100 maintains a higher voltage as compared to the typical lead-acid battery, due to its LFP chemistry. Furthermore, as shown in the graph, it is expected that the battery module assembly 100 is only discharged down to approximately 12 volts, as evidenced by the graph showing that the voltage of the battery module assembly 100 then drops to 12 volts at the end of the discharge cycle. Battery module assembly 100 can safely discharge up to 90% of its capacity in one discharge cycle.

In contrast, the lead-acid battery curve 1020 starts at a similar voltage, shown as 14.2 volts, and steadily decreases at a steady rate (i.e., there is no flat portion of the curve 1020) until it reaches 10.5 volts. Generally, the lead-acid battery typically should be discharged only to about 11.5 volts, and discharge 80% of its capacity. However, in order to increase the run-time of the lead-acid battery, some will discharge the lead-acid battery down to about 10.5 volts. Over-discharging in order to increase the present runtime of the lead-acid battery ultimately shortens the overall lifetime of the lead-acid battery.

Those skilled in the art will recognize that maintaining a higher voltage throughout most of the discharge cycle will increase the efficiency and reduce the performance variability in any loads, such as A/C compressors, heating elements, inverters, etc. Lead-acid batteries generally have a run-time of about 8 hours when new and 4-5 hours after multiple charge/discharge cycles, it is expected that battery module assembly 100 can achieve a run-time between 10 and 13 hours. This represents a significant benefit over the typical lead-acid batteries used in battery-powered APUs.

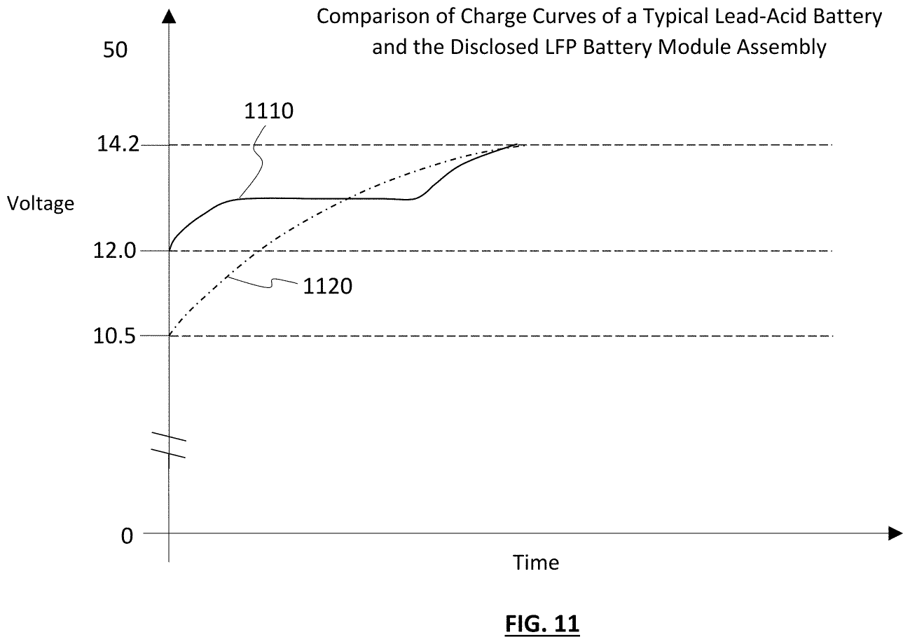

Turning now to FIG. 11, there is shown a graphical representation of the charge curve 1120 for a typical lead-acid battery (dash-dot line) as compared to a charge curve of battery module assembly 100, when both are charged at a constant voltage of 14.2 volts and are charged through the same cable resistance. Two obvious differences stand out immediately. First, the initial voltage for each is different. As stated above, it is contemplated that battery module assembly will only be discharged down to about 12 volts. The charge curve for the typical lead-acid battery 1120 shows a lower initial voltage of 10.5 volts. This assumes that the lead-acid battery will be discharged to that voltage. However, even if the lead-acid battery is not over-discharged, one could expect the initial voltage of the lead-acid battery at the beginning of the charge cycle to be about 11.5 volts. Thus, when completely discharged, i.e., when charging is necessary, battery module assembly 100 starts the charge cycle at a higher voltage value.

A second difference between the two curves 1110 & 1120 is the shape of each curve. The lead-acid battery charge curve 1120 shows a substantially linear increase to the terminal voltage of 14.2 volts. In contrast, and similar to the discharge curve, the battery module assembly charge curve 1110 exhibits an initial increase, then the charge curve 1110 flattens for the majority of the charge cycle, until finally increasing again to reach the terminal voltage of 14.2 volts. Those skilled in the art will recognize that with constant voltage and constant charge resistance in the charging circuit, a flatter voltage curve with a lower average voltage will reflect a higher average charge current. It should also be recognized that, despite having about two times the capacity of the lead acid battery, due to the higher average charge current, battery assembly 100 charges in about the same amount of time as a lead-acid battery. Lastly, it should be recognized that a higher initial voltage will result in a lower initial charge current, which could reduce the peak power, and therefore size and cost, of the alternator required, even given the above improvements in total charge time.

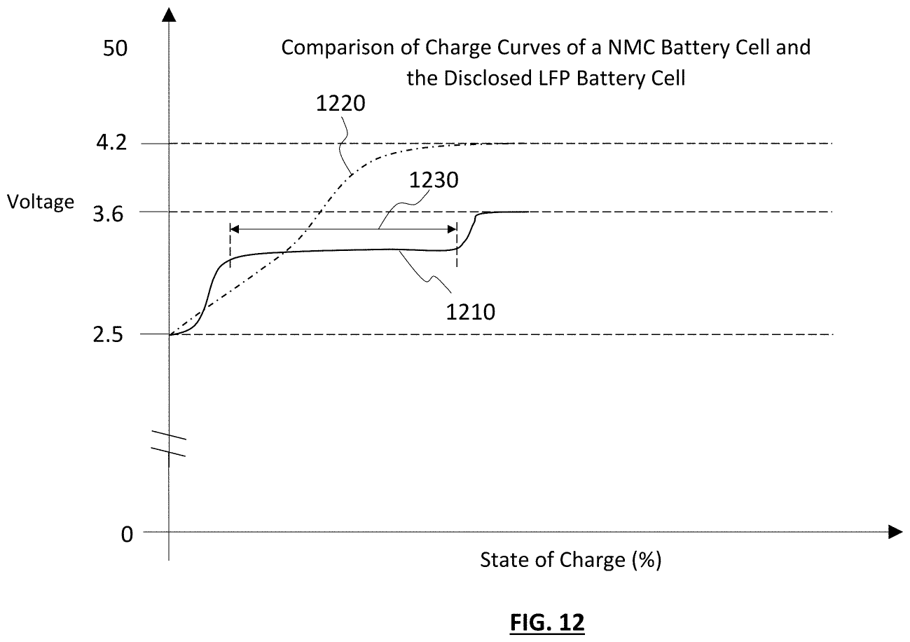

Turning now to FIG. 12, there is shown a graphical representation comparing, over time, the charge curve 1220 of a single lithium nickel manganese cobalt oxide (NMC) battery cell and the charge curve 1210 of the disclosed LFP battery cell 506 utilized in the battery module assembly 100. The charge curve of the NMC battery cell 1220 increases longer until it levels out at a higher voltage, shown here at 4.2 volts. In contrast, the LFP battery cell charge curve 1210 levels out sooner and remains at a constant voltage for longer. At the end of the charge cycle, LFP battery cell curve 1210 reaches 3.6 volts. When four cells 506 or cell banks 402 are in series, this represents the 14.2-14.4 volts of the fully charged battery module assembly 100, as seen in FIGS. 10 & 11.

As is evident from the graph of FIG. 12, the charge curve 1220 of an NMC battery cell exhibits a substantially steady increase to its terminal voltage. In contrast, as with the charge and discharge curves for the battery module assembly 100 seen in FIGS. 10 & 11, the charge curve 1210 of an individual LFP battery cell 506 initially increases relatively quickly to a flat portion of the curve. The charge curve 1210 remains relatively flat throughout most of the charge cycle.

### State of Charge Determination

The state of charge (“SOC”) of the lithium-ion battery cells 506 is continuously monitored by the BMS 602. When considering a state of charge curve, similar to the simplified graph seen in FIG. 12, lithium-ion battery cells 506 have a region where change in voltage is non-observable. This region, as seen in FIG. 12 as arrow 1230, shows that between approximately 5% charged and 80% charged, the ability to assess SOC for the lithium-ion battery cells 506 becomes difficult using standard methods. With the innovations of the current disclosure, the state of charge in this region is estimated using an equivalent-circuit cell model. The cell model output is comprised of two parts. The first part is an Open Circuit Voltage (“OCV”) which models the static voltage of the cell in an unloaded and equilibrium state. The second part is dynamic polarization of the cell voltage due to passage of current through the cell.

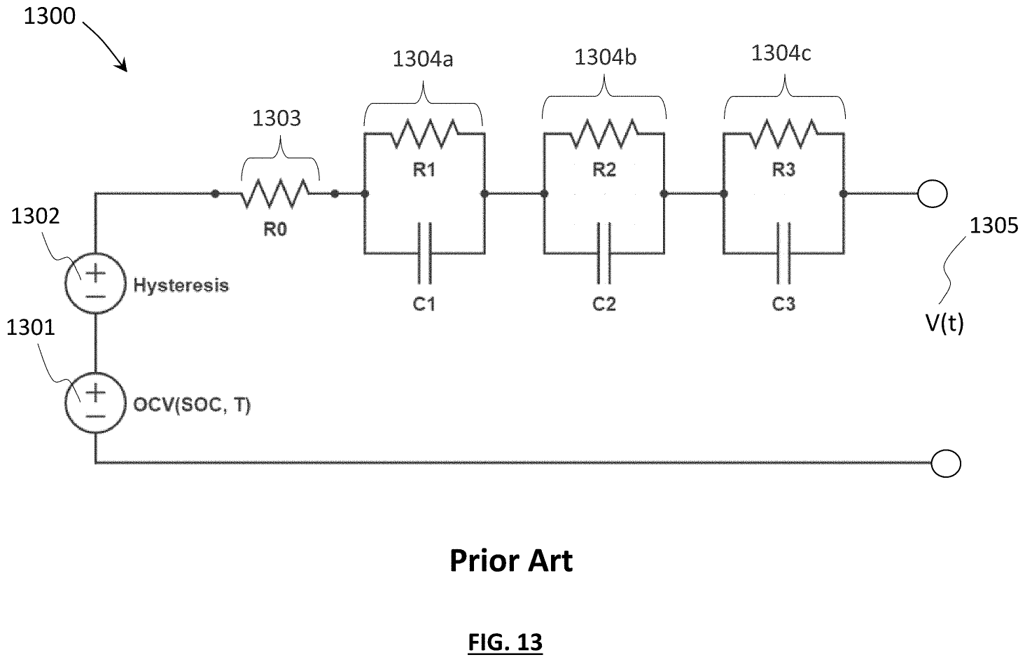

Turning to FIG. 13, the prior art shown is an “equivalent circuit” model 1300 used to simulate how a battery cell responds to certain load scenarios. The open circuit voltage source (“OCV”) 1301 models a battery cell with no load and in equilibrium. The OCV 1301 is a static function of state of charge (“SOC”) and Temperature (“T”). The hysteresis voltage 1302 models a departure of the cell's equilibrium rest voltage from OCV that depends on its current history. Theoretically, the hysteresis voltage is positive if the cell has been recently charged and is negative if the cell has been recently discharged. The hysteresis voltage 1302 has dynamics that are a function of cell current, and its magnitude may also be a function of SOC and cell current. Since the hysteresis voltage models how different the cell rest voltage is expected to be from OCV, neglecting the hysteresis voltage 1302 will result in SOC estimation errors. Resistor 1303 models the equivalent series resistance of the battery cells. The resistor-capacitor network pairs 1304a,1304b, 1304c model the diffusion voltages of the battery cells 506 and approximate a Warburg Impedance. Those of skill in the art should know that Warburg Impedance models the diffusion of lithium ions in electrodes. A voltage differential 1305 can be observed using the equivalent circuit model 1300 as described. Using the equivalent circuit model 1300, along with the associated math, data sets that describe a battery cell's 506 input/output relationship can be generated. The BMS 602 can then be calibrated to report a SOC sensibly during scenarios of varying load, temperature, and time conditions.

The processes for OCV characterization and dynamic parameter estimation make use of two independent data sets. During the calibration process, lithium-ion battery cells are tested in a cell cycler to acquire data. A cell cycler measures battery characteristics such as charge, maximum voltage, and minimum voltage. The OCV data includes measurements of current, voltage and charge at a number of temperature set points at, above, and below ambient temperature. The dynamic parameter estimation data includes measurements of current, voltage and charge, obtained similarly as the OCV data, with the addition of dynamic charge and discharge data. An Extended Kalman Filter (EKF) is programmed and calibrated into the BMS 602 to estimate internal cell states based on the current input and voltage output of the battery cells. It should be known by those of skill in the art that the EKF is a numerical method used to indirectly estimate values for variables that cannot be directly measured. Although the EKF is not the sole contributor for determining the state of charge, the importance of its contribution within the current disclosure should be noted.

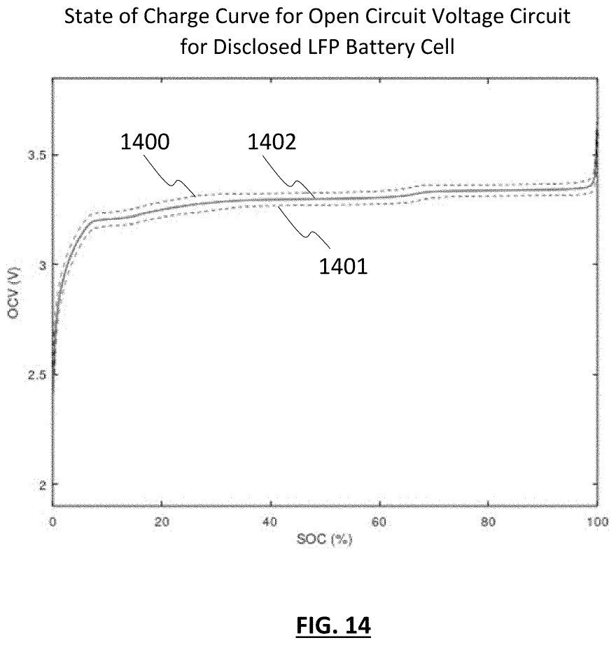

Turning to FIG. 14, a state of charge curve for the OCV model is shown. An OCV characterization uses low C-rate charge or discharge curves, shown as 1400 and 1401, to estimate a true OCV curve 1402 that lies between the measured curves 1400,1401. The measured curves 1400,1401 are generated from the data acquired using the cell cycler and methods as previously described. Those of skill in the art will know that the term “C-rate” refers to the level of a battery cell's discharge relative to the battery cell's capacity.

### Dual Chemistry

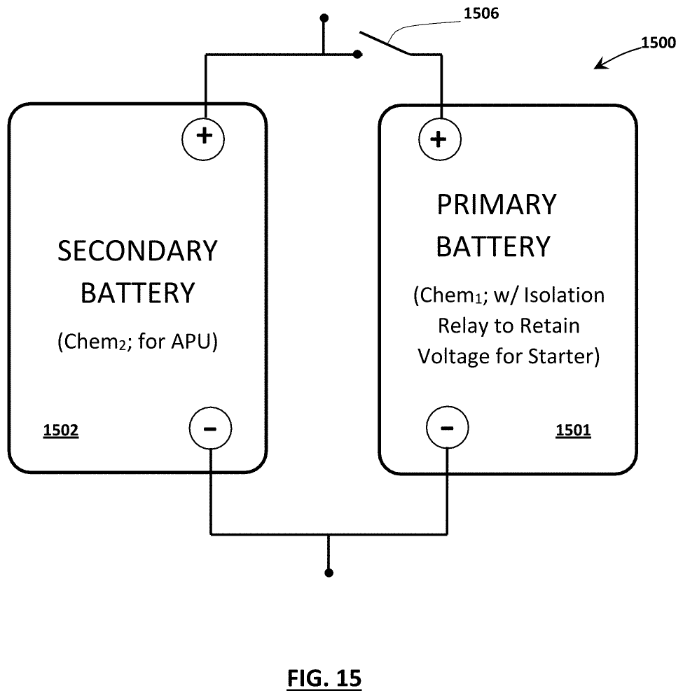

Referring to FIG. 15, there is shown a schematic representation of a conventional system 1500 incorporating two batteries—namely, primary battery 1501 and secondary battery 1502. The particular environment of the two batteries 1501 and 1502 is in the electric power system of a commercial truck (not shown), where they are normally connected in parallel (when relay 1506 is closed). In this illustration, battery 1501 is a conventional lead-acid battery (designated as having “Chem₁” in FIG. 15) and battery 1502 is a battery module assembly 100 (designated as having “Chem₂” in FIG. 15). Battery 1502 is incorporated into an auxiliary power unit (APU) as referenced, and battery 1502 is designated as the secondary battery and is alternatively referred to in this description as the APU battery. Battery 1501 is the battery used for starting the commercial truck and is designated as the primary battery in the system or is alternatively referred to as the starting battery in this description. It should be understood that each battery 1502, 1501 may actually each include multiple batteries so long as the voltages are nominally similar such as is recommended for the parallel configuration as shown.

As will be understood by those of skill in the art, APU battery 1502 is used, at least in part, to power a secondary HVAC system for use in the commercial truck, typically when the commercial truck is not being driven. When the engine of the truck is running, each battery 1501, 1502 is charged by the alternator (not shown) associated with the commercial truck. Secondary battery 1502 and primary battery 1501 are connected to each other in parallel. Because the starting battery 1501 must have a minimum charge to start the commercial truck, when the APU battery 1502 is being discharged, protection with an isolation relay 1506 is advisable to prevent over-discharge of the starting battery 1501.

For the purposes of maintaining a sufficient charge on starting battery 1501 for starting the commercial truck, prior systems are known to use a mechanism such as a relay 1506. When relay 1506 is closed, current may be drawn from each of the batteries 1502, 1501. In typical operation, when current is initially drawn and relay 1506 is closed, each battery 1502, 1501 will begin to be discharged. When primary battery 1501 is discharged to approximately 80% of its charge capacity, relay 1506 will be opened under control of BMS 602. The 80% charge capacity threshold is merely an example and other charge capacity thresholds maybe be selected so long as the remaining charge capacity of starting battery 1501 is sufficient to operate the starter for starting the commercial truck. When relay 1506 is open, as shown in FIG. 15, starting battery 1501 is effectively isolated such that current cannot be drawn from starting battery 1501. As stated above with respect to state of charge determination, BMS 602 continuously monitors the state of charge of battery module assembly 100. Accordingly, a threshold charge capacity may be set such that BMS 602 is able to open relay 1506 at that set charge capacity threshold to isolate battery 1501 in order to prevent over-discharge of that battery. An open relay 1506 only allows current to be drawn from APU battery 1502. This protects starting battery 1501 from over-discharging while the APU system is operating and while the commercial truck is not running, i.e., the commercial truck's engine is turned off. Relay 1506 may be incorporated into a battery isolator or separator device for the express purposes of isolating primary battery 1501 to prevent excessive discharge during the discharge cycle of primary battery 1502.

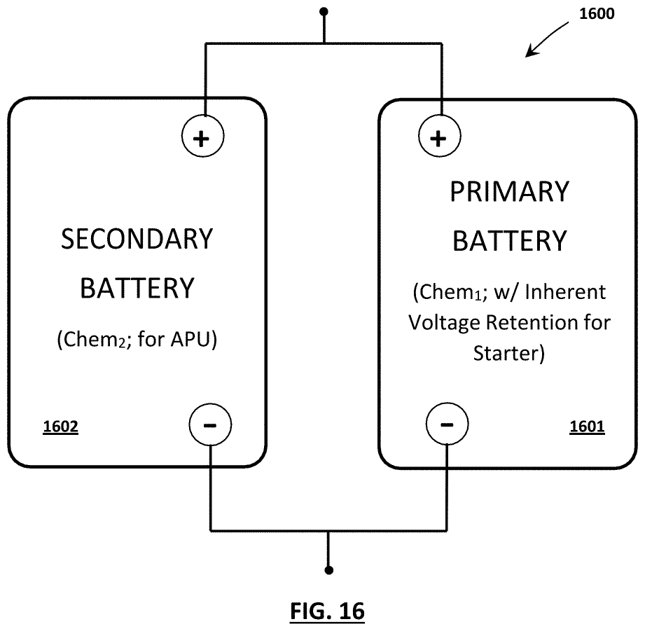

FIG. 16 represents a simplified schematic of another proposed dual chemistry battery system 1600 which uses two batteries—primary battery 1601 and secondary battery 1602—according to the teachings of the present invention. To the extent within the scope of the claims that are appended or later added to this description, the environment for the two batteries may be in any system where two batteries are being used in parallel, although the preferred embodiments are presently contemplated for use primarily in commercial trucks. A principal purpose for the primary battery 1601 is to effectively operate the starter for the truck's engine. The principal purpose of the secondary battery 1602, on the other hand, is to function as part of an electric APU for the truck. According to the principal teachings of the present invention, the primary battery 1601 is characterized by electric cells having one chemistry (“Chem₁”), while the secondary battery 1602 is characterized by electric cells having a second chemistry (“Chem₂”) that exhibits a more gradual voltage-to-state-of-charge discharge profile than does Chem₁.

More particularly, the secondary battery 1602 is a rechargeable lithium-ion battery connected in parallel to the primary battery 1601, which is wired and configured to serve as the starting battery for the commercial truck. Even more particularly, secondary battery 1602 is a lithium iron phosphate (LFP) battery. With respect to primary battery 1601, one requirement is that the chemistry of the primary battery have a steeper discharge profile from its more fully charged states than that of secondary battery 1602. In many embodiments, primary battery 1601 is a conventional lead-acid battery. However, primary battery 1601 may use any chemistry, including other lithium-ion-based chemistries, so long as it has a steeper discharge profile from its more fully charged states as compared to comparable discharge profiles for the chemistry used in secondary battery 1602.

When secondary battery 1602 and primary battery 1601 are connected in parallel, and when each battery 1601, 1602 is fully charged, once current is being drawn, there is a sequential discharge of the batteries 1602, 1601. More particularly, secondary battery 1602 will be discharged first followed by primary battery 1601, if necessary. This sequential discharge mimics what occurs when conventional systems incorporate a battery isolator and relay 1506 is opened; however, no active device such as a battery isolator is required in the system as illustrated in FIG. 16. When both batteries 1602, 1601 are completely discharged, there is also a sequential aspect to recharging each of the batteries 1602, 1601. Primary battery 1601 will charge first, followed by secondary battery 1602. It should be understood that, although preferred embodiments do not have an isolator relay, such relays or the like may also be used in combination with some variations of the present invention, to the extent consistent with the corresponding claims of the invention, when properly construed.

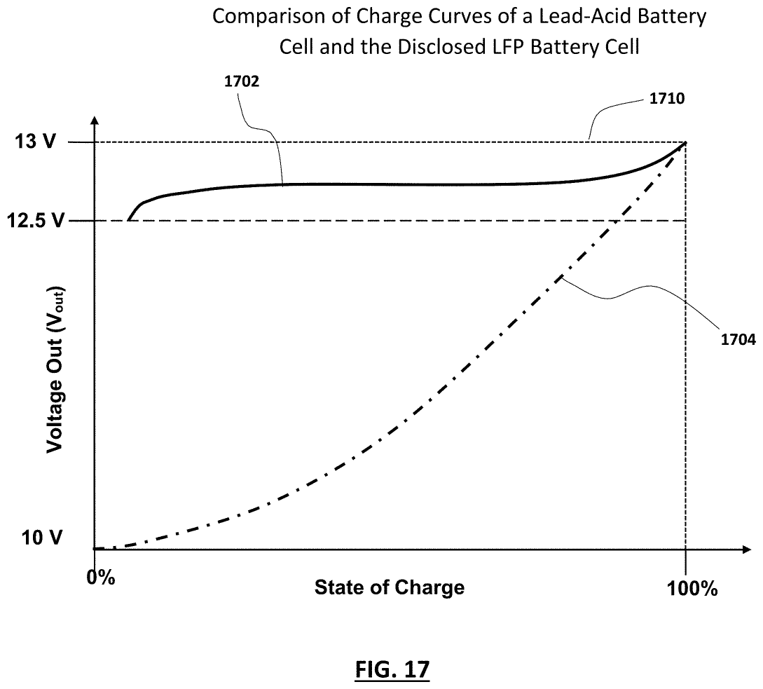

Turning now to FIG. 17, there is shown a graph of the voltage out of batteries 1602 and 1601 versus the state of charge (%) of each battery type. A battery's state of charge refers to the remaining useful energy in the battery at any given time. It should be understood that the values for the voltage as shown in the graph are exemplary and are not meant to be limiting. Curve 1702 represents the LFP APU battery 1602, and curve 1704 represents the conventional lead-acid starting battery 1601.

When selecting a combination of the different chemistries for batteries 1601 and 1602, two concepts should be considered in order to produce a sequential discharge without requiring intervention by any active devices, in line with the teachings of the present disclosure. One consideration is that the voltage output of the secondary battery 1602 should overlap, or at least have an overlapping section, with the voltage output of the primary battery 1601, but the profiles should be different, as evidenced by the representative curves illustrated in FIG. 17. To explain this concept, reference is made to box 1710, represented by the small-dash dashed line across the top and down the right side of the graph. The x-axis and y-axis of the graph represent the other two sides of box 1710. The voltage characteristics of the secondary battery 1602 should lie completely within box 1710. Another consideration is that any secondary battery 1602 contemplated for inclusion in the disclosed system should have a lower depletion of voltage per state of charge reduction as compared to primary battery 1601.

Curve 1702 represents the discharge profile of the LFP chemistry, which preferably characterizes secondary battery 1602. Curve 1704, on the other hand, represents the discharge profile of the lead-acid chemistry, which preferably characterizes primary battery 1601. As evident, the LFP curve 1702 is substantially flat over the vast majority of its useful charge range. In contrast, the lead-acid curve 1704 is steeper than curve 1702 (i.e., it has a much more significant slope per change in state of charge), particularly and most importantly in the upper portions (for example, the upper third) of its full state-of-charge range. Likewise, in alternative embodiments, any battery chemistry that has a curve that is steeper than the LFP curve 1702 in its upper portions of its state of charge could be optionally combined in the disclosed system with the LFP APU battery 1602 while still appreciating some aspects of the present invention. The voltage characteristics of LFP curve 1702 are shown to fit entirely within box 1710. Furthermore, LFP curve 1702 clearly has a much lower depletion of voltage over its state of charge range as compared to lead-acid curve 1704.

During operation of the disclosed dual chemistry battery system, current is drawn from both the APU battery 1602 and the lead-acid battery 1601. After an initial 3-5% drop in charge of the lead-acid battery 1601, the current ceases to be drawn from lead-acid battery 1601. Current continues to be drawn from APU battery 1602 through its discharge cycle, and if the current continues for a sufficient time period, APU battery 1602 will be completely discharged. Once APU battery 1602 is completely discharged, current may then be drawn from lead-acid battery 1601, if circumstances require as much.

### Active Balancing of Battery Banks

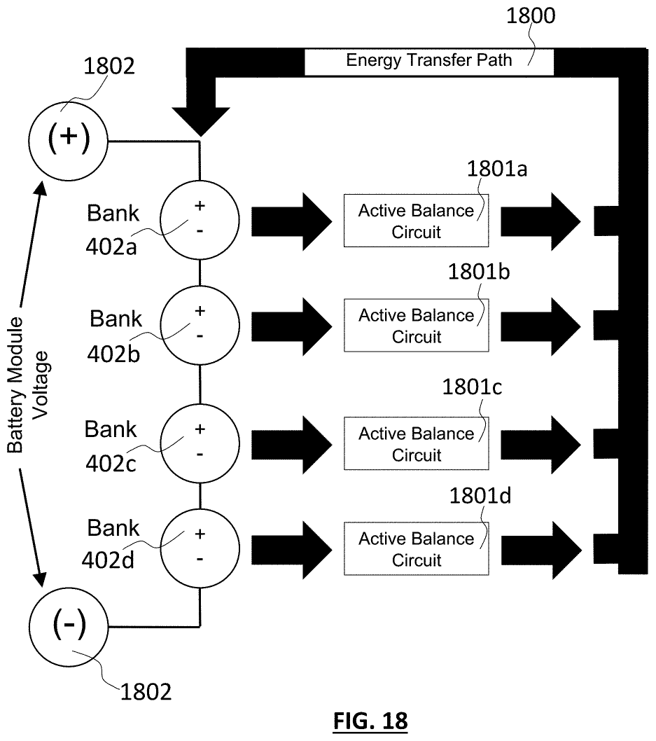

Turning now to FIG. 18, there is shown a block diagram illustrating the strategy for implementing active balancing for battery banks 402a-402d. Active balancing refers to a circuit that distributes energy amongst battery banks 402a-402b. The active balance circuit 1800 allows for a net transfer of energy, shown as the arrow 1800 in FIG. 18, from a single bank 402 to the remaining banks 402 in the system. If the state of charge and/or voltage 1802 of bank 402 is higher than the configurable limit, the respective circuit 1800 is activated. The circuit 1800 will discharge the bank 402 at a calibrated set point, thus enabling the stored energy in bank 402 to be transferred to the rest of the banks 402 in the system. Each circuit is capable of discharging a certain bank at a max rate of 2 amps. The discharge rate can be adjusted with a range from 0 amps to 2 amps. Alternative embodiments may have the capacity to support max discharge rates greater than 2 amps. Once the state of charge and/or voltage 1900 of bank 402 is below the calibrated limit, the circuit 1800 will deactivate and cease energy transfer between banks 402.

The number of active balance circuits 1800 is equal to the number of banks 402 connected in series, such that each bank 402 has a circuit 1800 that operates independently from the other banks 402. For example, an APU equipped with four battery banks 402 in series will have four active balance circuits 1800. Each circuit 1800 operates independently to allow management for each respective bank 402; looking to FIG. 18, it is evident for illustrative purposes that active balance circuit 1800a is linked to battery bank 402a, the same relations are applicable for circuits 1800b-1800d and respective battery banks 402b-402d. Each circuit 1800 has numerous fail-safe mechanisms (not shown) that force the circuit to a passive state if control is lost. It should be noted that the peak efficiency of each circuit is greater than 70%.

The drawings and detailed descriptions herein should be considered illustrative and not exhaustive. They do not limit the invention to the particular forms and examples disclosed. To the contrary, the invention includes many further modifications, changes, rearrangements, substitutions, alternatives, design choices, and embodiments apparent to those of ordinary skill in the art, without departing from the spirit and scope of this invention.

Accordingly, in all respects, it should be understood that the drawings and detailed descriptions herein are to be regarded in an illustrative rather than a restrictive manner and are not intended to limit the invention to the particular forms and examples disclosed. In any case, all substantially equivalent systems, articles, and methods should be considered within the scope of the invention and, absent express indication otherwise, all structural or functional equivalents are anticipated to remain within the spirit and scope of the presently disclosed systems and methods.

1. (canceled)

2. A lithium-ion auxiliary power supply for secondary systems in a commercial truck, the lithium-ion auxiliary power supply comprising:
a) a battery module assembly comprising, a plurality of lithium-ion battery cells, a positive bus terminal, a negative bus terminal, and an electrical connector;
b) a first charge cable having a first end and a second end, the first charge cable being:
1) operatively coupled to the positive bus terminal at the first end of the first charge cable; and
2) operatively coupled to an alternator associated with the commercial truck at the second end of the first charge cable;
c) a second charge cable having a first end and a second end, the second charge cable being:
1) operatively coupled to the negative bus terminal at the first end of the second charge cable; and
2) operatively coupled to the alternator associated with the commercial truck at the second end of the second charge cable;
d) a first remote sense wire and a second remote sense wire, wherein:
1) each of the first remote sense wire and the second remote sense wire are operatively coupled to the electrical connector at a first end of each of the first remote sense wire and the second remote sense wire; and
2) the second remote sense wire is operatively coupled to the alternator associated with the commercial truck at a second end of the second remote sense wire; and
e) a battery management system (BMS) operatively coupled to the electrical connector, the BMS being adapted to provide an offset voltage to a remote sense input of the alternator associated with the commercial truck, wherein the alternator associated with the commercial truck is configured to increase a voltage output to compensate for the offset voltage.

3. The lithium-ion auxiliary power supply as defined in claim 2, wherein the plurality of lithium-ion battery cells are lithium iron phosphate (LFP) battery cells, and
wherein the first remote sense wire is operatively coupled to a positive terminal of a starting battery associated with the commercial truck at a second end of the first remote sense wire.

4. The lithium-ion auxiliary power supply as defined in claim 2, wherein a first pin of the electrical connector is an input, and a second pin in the electrical connector is an output.

5. The lithium-ion auxiliary power supply as defined in claim 2, wherein the BMS is adapted to limit a magnitude of the offset voltage such that the offset voltage does not violate the voltage or current limits of the alternator associated with the commercial truck, the voltage limits of a starting battery associated with the commercial truck, voltage limits of other electrical systems associated with the commercial truck, or a voltage limit of the battery module assembly, and
wherein the increased voltage output from the alternator associated with the commercial truck to compensate for the offset voltage causes an increase in charge current to the battery module assembly.

6. The lithium-ion auxiliary power supply as defined in claim 2, wherein each lithium-ion battery cell in the plurality of lithium-ion battery cells is interconnected via wire bonding to a printed circuit board (PCB) on a top side of the lithium-ion battery cells.

7. The lithium-ion auxiliary power supply as defined in claim 6, wherein the wire bonding of each lithium-ion battery cell consists of three wires, wherein one of the three wires is positive and two of the three wires are negative.

8. The lithium-ion auxiliary power supply as defined in claim 2, further comprising a plurality of active balancing circuits, wherein each active balancing circuit is associated with a bank of lithium-ion battery cells, and wherein each active balancing circuit is configured to discharge excess energy from the associated bank of lithium-ion battery cells and transfer the excess energy to one or more other banks of lithium-ion battery cells.

9. The lithium-ion auxiliary power supply as defined in claim 8, wherein each active balancing circuit is configured to operate independently of any other active balancing circuit.

10. The lithium-ion auxiliary power supply as defined in claim 2, wherein each of the lithium-ion battery cells is a lithium iron phosphate (LFP) battery cell.

11. The lithium-ion auxiliary power supply as defined in claim 2, wherein outer dimensions of the battery module assembly are consistent with a double-length Group 31form factor.

12. A method for decreasing a charge time for a lithium-ion battery auxiliary power supply for secondary systems in a commercial truck, the method comprising:
a) coupling a first end of a first charge cable to a negative bus terminal of a lithium-ion battery module assembly;
b) coupling a second end of the first charge cable to an alternator associated with the commercial truck;
c) coupling a first end of a second charge cable to a positive bus terminal of the lithium-ion battery module assembly;
d) coupling a second end of the second charge cable to the alternator associated with the commercial truck;
e) coupling a first end of a first remote sense wire to an electrical connector of the lithium-ion battery module assembly;
f) coupling a second end of the first remote sense wire to a positive terminal of a starting battery associated with the commercial truck;
g) coupling a first end of a second remote sense wire to the electrical connector of the lithium-ion battery module assembly;
h) coupling a second end of the second remote sense wire to the alternator associated with the commercial truck;
i) sensing, at the second end of the first remote sense wire, a voltage of the starting battery;
j) sensing, at the second end of the second remote sense wire, a charge current of the alternator associated with the commercial truck;
k) providing an offset voltage to a remote sense input of the alternator associated with the commercial truck, wherein the alternator associated with the commercial truck is configured to increase voltage output to compensate for the offset voltage, and wherein the increased voltage output causes an increase in charge current from the alternator associated with the commercial truck to the lithium-ion battery module assembly.

13. The lithium-ion auxiliary power supply as defined in claim 2, wherein:
the secondary systems includes a heating ventilation and air conditioning (HVAC) system associated with the commercial truck; and
the battery module assembly includes a plurality of battery modules.

14. The lithium-ion auxiliary power supply as defined in claim 2, wherein:
the battery module assembly further comprises:
a top battery cell tray and a bottom battery cell tray, and
an aluminum enclosure base including a plastic lid; and
each of the plurality of lithium-ion battery cells is held in place between the top battery cell tray and the bottom battery cell tray using an adhesive.

15. The lithium-ion auxiliary power supply as defined in claim 2, wherein:
the first and second charge cables are configured to operatively couple the battery module assembly and the alternator; and
the operative coupling enables the alternator to charge the battery module assembly.

16. The lithium-ion auxiliary power supply as defined in claim 2, wherein:
a portion of the plurality of lithium-ion battery cells comprise a positive cell array, and another portion of the plurality of lithium-ion battery cells comprise a negative cell array; and
the positive cell array includes the BMS, the BMS further adapted to monitor operative aspects of the lithium-ion battery cells, wherein the operative aspects include cell voltage, cell current, and temperature.
